(19) United States
(12) Patent Application Publication
(10) Pub. No.: US 2026/0357632 A1
(43) Pub. Date: Nov. 12, 2026

(54) DOOR DRIVE FOR A VEHICLE DOOR

(71) Applicant: Brose Fahrzeugteile SE & Co. Kommanditgesellschaft, Bamberg, Bamberg (DE)

(72) Inventor: Björn TRÖSTER, Sonneberg (DE)

(21) Appl. No.: 19/515,330

(22) PCT Filed: Aug. 26, 2024
(86) PCT No.: PCT/EP2024/073839

§ 371 Date: Feb. 27, 2026

(30) Foreign Application Priority Data
Aug. 28, 2023 (DE) 10 2023 123 023.9

(51) Int. Cl. E05F 15/611

(52) U.S. Cl. CPC E05F 15/611; E05Y 2600/46; E05Y 2900/531

(57) ABSTRACT

The invention relates to a door drive (1) for a vehicle door (2), comprising: a housing (10) on which a first mounting region (M1) for mounting the housing (10) on the vehicle door (2) is fixed or formed; a movement part (11) having a second mounting region (M2) for mounting the movement part (11) on a vehicle chassis (3); an electrical drive unit (12) for causing the movement part (11) to move relative to the housing (10); and a holding element (13) having a third mounting region (M3) for mounting the holding element (13) on the vehicle door (2), wherein the holding element (13) has two ends (130, 131) which can be interconnected in order to fix the holding element (13) to the housing (10).

The invention relates to a door drive for a vehicle door, a vehicle door with such a door drive, and a method for pre-mounting a door drive.

Electrical door drives allow for particularly comfortable entry into and exit from a vehicle. In this case, electrical door drives can make it easier to open and close even heavy doors on slopes or inclines.

Typically, electrical door drives are mounted inside a vehicle door. However, the available installation space is severely limited there. At the same time, strong accelerations and vibrations sometimes occur in the vehicle, which is why door drives, which are usually attached to a first mounting region on the vehicle door and to a second mounting region on a vehicle chassis, can rub against an inner door panel, a side window or the like.

CN 218467423 U describes a door drive which has a third mounting region that is spaced apart from the other two mounting regions and on which the door drive can be mounted, for example, on the vehicle door. However, this solution can sometimes be complex to manufacture and mount.

The object is to provide an improved door drive.

This object is achieved by the subject matter having the features of claim 1.

According thereto, a door drive for a vehicle door comprises a housing on which a first mounting region for mounting the housing on the vehicle door is fixed or formed, a movement part having a second mounting region for mounting the movement part on a vehicle chassis, an electrical drive unit for causing the movement part to move (e.g. linearly) relative to the housing, and a holding element having a third mounting region for mounting the holding element on the vehicle door. In this case, it is provided that the holding element has two ends, which can be interconnected, in particular locked, in order to fix the holding element on the housing.

This is based on the finding that the same door drive design with identically designed parts can be used in different types of vehicle doors by making the third mounting region fixable to the housing in a variable manner and as required. This allows the holding element to be pre-mounted on the housing, which facilitates easier and more precise installation in the vehicle door. This allows for the use of a particularly large number of identical parts and at the same time facilitates mounting.

By connecting, in particular by locking, the two ends to each other, the previously open holding element is closed, in particular in the form of a clamp.

The ends of the holding element can form the third mounting region. The mounting of the third mounting region thus allows for a particularly secure fixing of the two ends to each other.

One of the ends may have one or more locking hooks, which can be locked to one or more locking edge(s) of the other end. This allows for particularly easy mounting of the holding element on the housing.

A screw boss can be formed at one of the ends of the holding element, in particular a screw boss for a self-tapping screw. This allows for particularly easy mounting on the vehicle door and simultaneous secure fixing of the ends to each other.

At the opposite end of the holding element in each case, a contact surface can be formed, e.g. facing away from the screw boss, for contact with the vehicle door. For example, a fixation of the holding element by means of a screw can press the two ends against each other.

For example, the holding element has a contour that matches the housing. This enables a secure, form-fitting connection.

It may be provided that the holding element can be plugged onto the housing. In particular, the housing can be pluggable through the holding element. This allows for easy mounting and precise positioning for the respective application.

It may also be provided that the holding element can be fixed at any one of a plurality of different (in particular predetermined) positions on the housing. This allows the third mounting region to be positioned as is required in the respective application, it being possible for identical parts to be used for the different applications.

The holding element can be movable to a selected one of the different positions on the housing when the ends are unlocked, and can be fixable in the selected position on the housing by locking the ends together. This allows for particularly easy pre-mounting of the holding element before installation in the vehicle door. This not only provides transport security but also facilitates mounting in the vehicle door.

The housing can have a plurality of form-fitting elements. The holding element can have at least one form-fitting element. In this case, it may be provided that the at least one form-fitting element of the holding element can be brought into engagement, along the housing, with at least any one of the form-fitting elements of the housing. This allows for easy fixing in one of a plurality of predefined positions.

The form-fitting elements of the housing and the at least one form-fitting element of the holding element are, for example, each designed in the form of ribs. This allows for easy manufacturing and easy positioning.

The at least one form-fitting element of the holding part can be arranged, for example, in a form-fitting manner between two form-fitting elements of the housing. It is thus possible to prevent the holding element, with the locked ends, from slipping and leaving the selected position.

It may be provided that the holding element has a plurality of, in particular flat, contact surfaces for full-surface contact with the housing. This allows for secure holding of the holding element on the housing.

Furthermore, the housing may have in particular longitudinally extended sliding surfaces, along which the contact surfaces slide when the holding element is pushed along the housing. This allows for particularly simple mounting. The sliding surfaces (and/or the contact surfaces) can be coated, e.g. with a friction-reducing layer, such as Teflon. However, such a layer is not necessary.

According to one aspect, a vehicle door is specified, which comprises a door drive according to any of the embodiments described herein. Regarding the advantages, reference is made to what has been stated above.

According to one aspect, a method for pre-mounting a door drive according to any of the embodiments described herein is specified. The method comprises the following steps: selecting one of a plurality of different positions on the housing, plugging the holding element onto the housing as far as to the selected position, and locking the ends of the holding element together in order to fix the holding element in the selected position on the housing. Regarding the advantages, reference is once again made to what has been stated above.

The attached figures illustrate, by way of example, possible variants of the proposed solution.

### In the Figures:

FIG. 1 shows part of a vehicle door, part of a vehicle chassis, and a door drive;

FIG. 2-4 are further views of the door drive according to FIG. 1;

FIG. 5A-5C are various views of a holding element of the door drive according to FIG. 1, the ends of the holding element not being locked together;

FIG. 6A-6D are various views of the holding element of the door drive according to FIG. 1, the ends of the holding element being locked together;

FIG. 7 is a view according to the sectional plane A-A shown in FIG. 6D; and

FIG. 8 is a view according to the sectional plane B-B shown in FIG. 3.

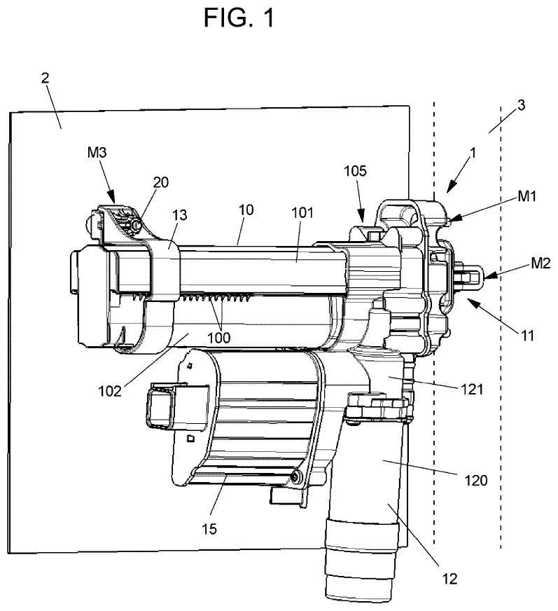

FIG. 1 shows an electrical door drive 1 in a state installed on a vehicle door 2, which is shown only schematically here. The vehicle door 2 can be opened and closed by means of the door drive 1. In the present case, the vehicle door 2 is a side door. Thus, in the present case, the door drive 1 represents, by way of example, a side door drive. With the aid of the door drive 1, the vehicle door 2 can be comfortably opened and closed, even on slopes or when the vehicle, with the vehicle door 2, is tilted. Even though the vehicle door 2 is relatively heavy, the door drive 1 makes it easier to operate.

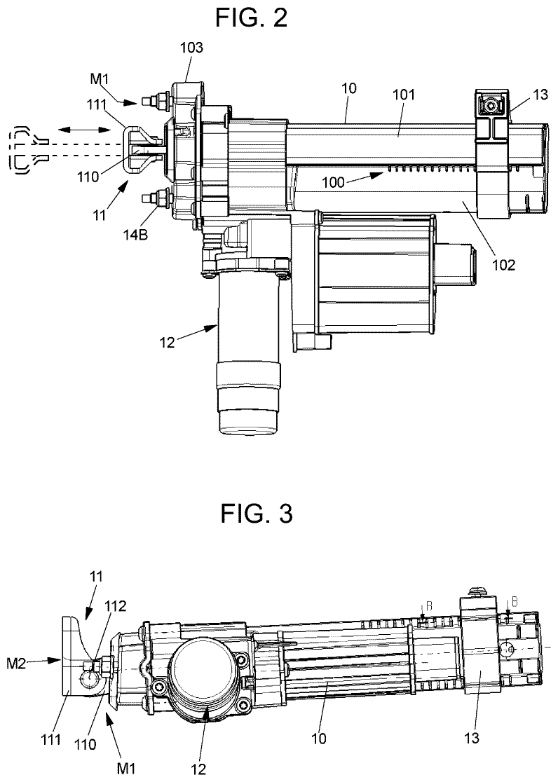

The door drive 1 comprises a housing 10, a movement part 11 and a drive unit 12. The movement part 11 can be moved relative to the housing 10 by activating the drive unit 12. In the present case, it is provided that the movement part 11 is translationally movable relative to the housing 10. Specifically, the movement part 11 can be retracted into the housing 10 and extended out of the housing 10 for the purpose of movement, as illustrated in FIG. 2.

The housing 10 comprises an elongated region, at the end of which an attachment 105 is fitted. The elongated region of the housing 10 is, for example, made of metal. The attachment 105, for example, is made of plastics material, but other embodiments are also conceivable. The elongated region of the housing 10 has an upper elongated portion 101 and a lower elongated portion 102. In the example shown, the upper portion 101 of the housing 10 is made of metal, the lower portion 102 of plastics material.

The movement part 11 can be retracted into (and extended out of) the upper portion 101. In the lower portion 102 a spindle (or alternatively a rack or the like) of the drive unit 12 is arranged, by means of which the movement part 11 can be moved.

A first mounting region M1 is provided on the housing 10, for mounting the housing 10 on the vehicle door 2. In the present case, the first mounting region M1 is fixed on the attachment 105 of the housing 10, but could also be formed or fixed on the housing 10 in another way. The first mounting region M1 is formed here by a mounting portion 103, which is mounted on the attachment 15. In the present example, the first mounting region M1 comprises two screw holes. The first mounting region M1 is mounted on the vehicle door 2 at the screw holes using screws 14B (see e.g. FIG. 2), in the present case on a pillar of the vehicle door 2 (not shown in FIG. 2).

The movement part 11 has a second mounting region M2 for mounting the movement part 11 on a vehicle chassis 3. The vehicle chassis 3, illustrated by dashed lines in FIG. 1, carries the vehicle door 2 on hinges (not shown here). The vehicle door 2 is pivotably mounted on the vehicle chassis 3.

The movement part 11 comprises an elongated rod 110, which can be retracted into the housing 10, and a mounting plate 111 provided at one end of the rod 110. The mounting plate 111 is arranged outside the housing 10 in every position of the movement part 11 relative to the housing 10. The mounting plate 110 is pivotally mounted on the rod 110 by means of a swivel joint 112, see e.g. FIGS. 3 and 4. A screw hole 113 is formed on the mounting plate 110. The movement part 11 can be mounted on the vehicle chassis 3 via the screw hole 113. The mounting plate 110 thus forms the second mounting region M2.

By causing the electrical drive unit 12 to move the movement part 11 relative to the housing 10, the door drive 1 consequently pushes the vehicle door 2 open or closed, depending on the movement direction.

For this purpose, the drive unit 12 comprises a motor 120 and a transmission 121 driven by the motor 120. In the present example, the transmission 121 is operatively connected to the spindle in the housing 10 and drives it. A control device 15 controls the operation of the drive unit 12.

The door drive 1 further comprises a holding element 13 having a third mounting region M3 for mounting the holding element 13 on the vehicle door 2. The holding element 13 is attached to the housing 10, and specifically in the present case to a region of the housing 10 facing away from the attachment 105. In the mounted state, the holding element 13 is closed and surrounds the housing 10. The housing 10 extends through the holding element 13. Parts of the housing 10 are arranged along the holding element 13 on both sides thereof.

The holding element 13 is initially unlocked for mounting on the housing 10, and can be locked to it for fixing.

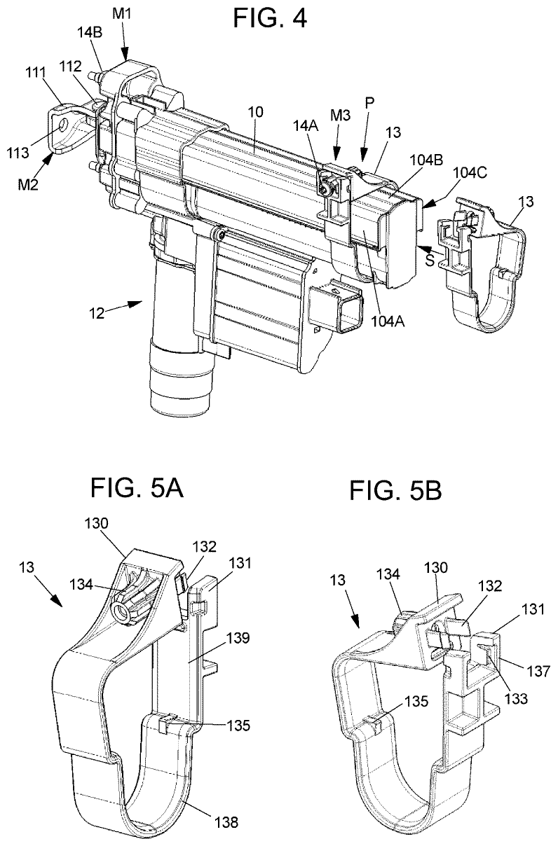

FIG. 5A-5C show the holding element 13 in the unlocked, i.e. open, state. It can be seen that the holding element 13 has two ends 130, 131. The holding element 13 is in the shape of a flat band, in portions. The ends 130 and 131 represent the open ends of the band. One end 130 of the ends 130, 131 has at least one locking hook, in the present case two locking hooks 132. The other end 131 has at least one, here two, corresponding locking edges 133. The locking hooks 132 can be locked to the locking edges 133.

Furthermore, one end (here the end with the locking hooks 132) has a screw boss 134. The screw boss 134 has a screw hole for a self-tapping screw 14A (see e.g. FIG. 4). The screw boss 134 has a plurality of reinforcing ribs. A through-hole through the screw boss 134 is arranged between the two locking hooks 132.

Two form-fitting elements 135 are formed on an inner side of the holding element 13, in the present case each in the form of a protruding rib. In the open state of the holding element 13, the form-fitting elements 135 are so far apart (or can be moved so far apart) from one another that the holding element can be axially plugged onto the housing 10.

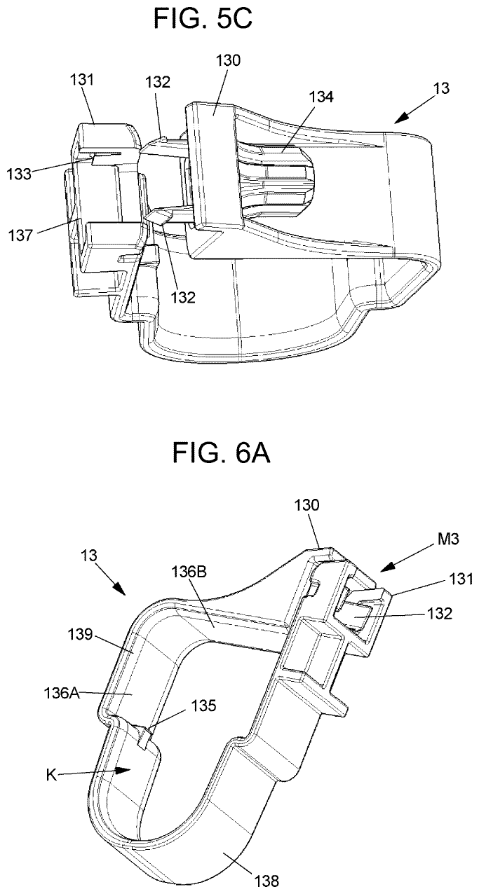

FIG. 6A-6D show the holding element 13 separately in the locked state. Here, the locking hooks 132 are locked to the locking edges 133. The holding element 13 has an inner contour K which is shaped to fit the housing 10, and specifically is shaped to an outer contour of the housing 10.

The holding element 13 describes a U-shaped portion 138 and a rectangular portion 139. The U-shaped portion 138 is shaped to fit the lower elongated portion 102, the rectangular portion 139 to fit the upper elongated portion 101 of the housing 10. The rectangular portion 139 has a greater width than the U-shaped portion 138. At the transition between the U-shaped portion 138 and the rectangular portion 139, a step is formed on both sides. In each case one of the two form-fitting elements 135 is formed on each of the two steps. The two form-fitting portions 135 are aligned with each other.

In the state when locked together, one end 130 meets the other end 131 perpendicularly. One front wall of the end 130 abuts the other end 131 over a flat surface. The screw boss 134 is fixed to the front wall. Side walls on both sides of the screw boss 134 stabilize the front wall and thus the screw boss 134. A projection extending from the front wall forms an inclined surface which reaches over the other end 131. This projection facilitates the precise positioning of the ends 130, 131 relative to each other and ensures that the ends 130, 131 hold to one another.

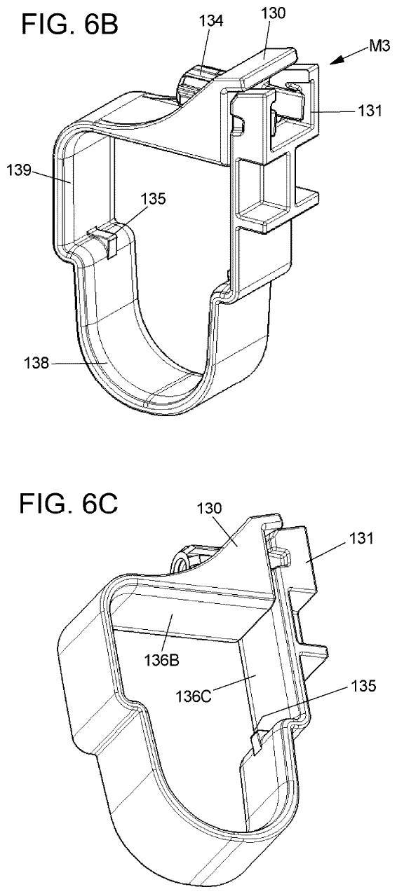

The end 131 at which the screw boss 134 is not provided has an opening for a screw 14A to be screwed into the screw boss 134 at the other end 130, as can be seen in particular from the cross-section according to FIG. 7. This end 131 forms a contact surface 137 for contact, in particular for full-surface contact on the vehicle door 2, specifically on an inner door panel of the vehicle door 2.

Three contact surfaces 136A-136C are formed on the rectangular portion 139. The contact surfaces 136A-136C are flat. Two of the contact surfaces 136A, 136C are opposite each other and are aligned parallel to each other. A further contact surface 136B is aligned perpendicularly to the two other contact surfaces 136A, 136C.

The contact surfaces 136A-136C slide along sliding surfaces 104A-104C of the housing 10 during the mounting of the holding element 13 on the housing 10. The sliding surfaces 104A-104C are formed on the upper elongated portion 101. The sliding surfaces 104A-104C are each flat. The sliding surfaces 104A-104C are each longitudinally extended. The opened holding element (see FIG. 5A-5C) can be pushed along the sliding surfaces 104A-104C, as illustrated in FIG. 4. Depending on which vehicle or vehicle door the door drive 1 is to be mounted in or on, respectively, the holding element 13 can be pushed less far or further onto the housing 10. For this purpose, the holding element 13 can be plugged onto the housing 10. In this case, the holding element 13 is plugged onto the housing 10 along a plugging direction S and pushed as far as a predetermined position P on the housing 10.

A plurality of form-fitting elements 100 are formed on the housing 10. As can be seen in particular from FIG. 1-3 and 8, the form-fitting elements 100 are each designed in the form of a rib. In this case, the form-fitting elements 100 are arranged in a row along the length of the housing 10. The length of the housing 10 is parallel to the displacement direction of the movement part 11 relative to the housing 10, see in particular FIG. 2. The length of the housing 10 is also parallel to the plugging direction S.

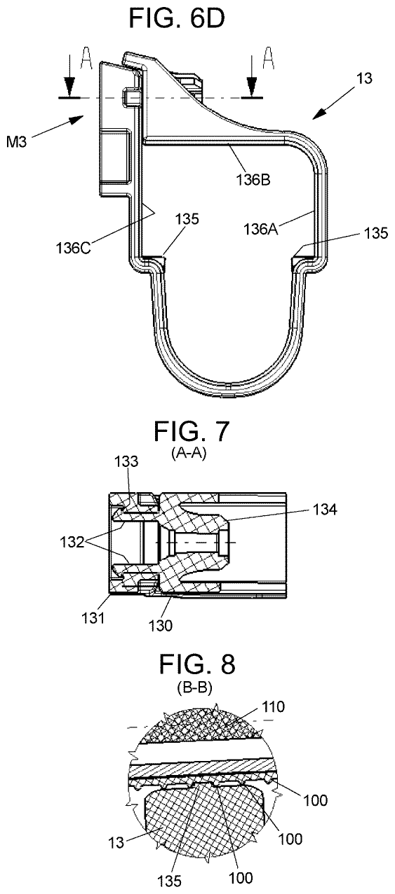

The form-fitting elements 100 are formed at the transition between the two portions 101, 102 of the housing 10, specifically at a bend between the two portions 101, 102. As can be seen in particular from FIG. 8, the form-fitting elements 135 of the holding element 13 can each be arranged between two adjacent form-fitting elements 100 of the housing 10.

In the vehicle, the length of the housing 10 runs along the vehicle longitudinal direction X. Thus, the housing 10 allows the mounting of the holding element 13 at a plurality of possible positions P along the length of the housing 10, and accordingly along the vehicle longitudinal direction X.

The two ends 130, 131 of the holding element 13 can be connected to each other for fixing the holding element 13 on the housing 10. If the holding element 13 is positioned at the selected position P, the ends can be locked together. In this case, the two form-fitting elements 135 of the holding element 13 engage between the form-fitting elements 100 of the housing 10 and thus lock these in a form-fitting manner. In this case, the holding element 13 can be fixed at any of the plurality of different positions P on the housing 10. The contact surfaces 136A-136C of the holding element 13 then lie in full-surface contact with the housing 10, specifically with the sliding surfaces 104A-104C at the corresponding position P.

A method for pre-mounting the door drive 1 therefore comprises selecting one of a plurality of different positions P on the housing 10, plugging the holding element 13 onto the housing 10 as far as to the selected position P, and locking the ends 130, 131 of the holding element 13 together in order to fix the holding element 13 in the selected position P on the housing 10. The self-tapping screw 14A can also be pre-mounted. Thus, it only needs to be screwed onto the vehicle door 2 after it has been threaded through a keyhole there.

Pre-mounted in this way, the holding element 13 is secured at the correct position P for transport and during mounting on the vehicle door 2. There, the self-tapping screw 14A is then screwed through a hole in the inner door panel into the screw boss 134. In this case, the two ends 130, 131 are pressed even more firmly together and pressed with the contact surface 137 against the inner door panel. In this case, the pre-mounting of the holding element 13 acts as a mounting aid in the case of mounting via a keyhole on the inner door panel. The contact surface 137 faces away from the screw boss 134. The holding element 13 then secures the housing 10 in a play-free manner against movements in the directions Y and Z perpendicular to the vehicle longitudinal direction. Unlike door drives that are conventional in practice, with only two mounting regions, in this way scuffing on inner sides of the vehicle door is prevented, and furthermore a smaller distance can be selected, and thus a more planar design of the vehicle door. In the mounted state, the door drive 1 is then mounted on the three mounting regions M1-M3, which are spaced apart from one another in each case.

The mounting regions M1-M3 represent screw-on points. The third screw-on point (third mounting region M3) provides an additional locking mechanism for the side door drive on the inner door panel. The holding element 13 represents a clamp. The contact surfaces 136A-136C represent clamping surfaces. The form-fitting elements 100, 135 form a tongue-and-groove system.

### LIST OF REFERENCE SIGNS

1 door drive
10 housing
100 form-fitting elements
101, 102 portion
103 mounting portion
104A-104C sliding surface
105 attachment
11 movement part
110 rod
111 mounting plate
112 swivel joint
113 screw hole
12 drive unit
120 motor
121 transmission
13 holding element
130, 131 end
132 locking hook
133 locking edge
134 screw boss
135 form-fitting element
136A-136C contact surface
137 contact surface
138 U-shaped portion
139 rectangular portion
14A, 14B screw
15 control unit
2 vehicle door
3 vehicle chassis
K contour
M1-M3 mounting region
P position
S plugging direction

1. A door drive for a vehicle door, comprising:
a housing on which a first mounting region (M1) for mounting the housing on the vehicle door is fixed or formed,
a movement part having a second mounting region (M2) for mounting the movement part on a vehicle chassis
an electrical drive unit for causing the movement part to move relative to the housing, and
a holding element having a third mounting region (M3) for mounting the holding element on the vehicle door,
wherein
the holding element has two ends which can be interconnected in order to fix the holding element to the housing.

2. The door drive according to claim 1, wherein the ends, of the holding element form the third mounting region (M3).

3. The door drive according to claim 1, wherein one of the ends has locking hooks which can be locked with locking edges of the other end.

4. The door drive according to claim 1, wherein a screw boss for a self-tapping screw is formed at one of the ends.

5. The door drive according to claim 4, wherein a contact surface facing away from the screw boss for contact with the vehicle door, is formed at the other of the ends.

6. The door drive according to claim 1, wherein the holding element has a contour (K) that matches the housing.

7. The door drive according to claim 1, wherein the holding element can be plugged onto the housing.

8. The door drive according to claim 1, wherein the holding element can be fixed at any of a plurality of different positions (P) on the housing.

9. The door drive according to claim 8, wherein the holding element, in an unlocked state of the ends is movable on the housing into a selected one of the different positions (P) and can be fixed in the selected position (P) on the housing by locking the ends together.

10. The door drive according to claim 1, wherein the housing has a plurality of form-fitting elements and the holding element has at least one form-fitting element, it being possible for the at least one form-fitting element (135) of the holding element to be brought into engagement, along the housing, with at least any one of the form-fitting elements of the housing.

11. The door drive according to claim 10, wherein the form-fitting elements of the housing and the at least one form-fitting element of the holding element are designed in the form of ribs.

12. The door drive according to claim 10, wherein the at least one form-fitting element of the holding part can be arranged in a form-fitting manner between two form-fitting elements of the housing.

13. The door drive according claim 1, wherein the holding element has a plurality of flat contact surfaces for full-surface contact with the housing.

14. The door drive according to claim 13, wherein the housing has longitudinally extended sliding surfaces, along which the contact surfaces slide when the holding element is pushed along the housing.

15. The vehicle door comprising a door drive according to claim 1.

16. A method for pre-mounting a door drive according to claim 1, comprising:
selecting one of a plurality of different positions (P) on the housing,
plugging the holding element onto the housing as far as to the selected position (P), and
locking the ends of the holding element together, in order to fix the holding element in the selected position (P) on the housing.
